(19) United States
(12) Patent Application Publication
(10) Pub. No.: US 2022/0212626 A1
(43) Pub. Date: Jul. 7, 2022

(54) Antitheft protection device

(71) Applicant: Nelson R. De La Nuez, Orlando, FL (US)

(72) Inventor: Nelson R. De La Nuez, Orlando, FL (US)

(21) Appl. No.: 17/702,392

(22) Filed: Mar. 23, 2022

Related U.S. Application Data
(63) Continuation-in-part of application No. 16/695,039, filed on Nov. 25, 2019, now Pat. No. 11,326,856.
Application No. 16/695,039 is a continuation-in-part of application No. 16/417,556, filed on May 20, 2019, now abandoned.

(51) Int. Cl. B60R 25/01; E05B 73/00; B32B 1/00; B32B 5/02; B32B 5/10; B32B 5/26; B32B 7/022; B32B 7/09; B32B 7/12; B32B 15/02; B32B 15/14; B32B 15/18

(52) U.S. Cl. CPC B60R 25/01; B32B 2605/00; B32B 1/00; B32B 5/022; B32B 5/024; B32B 5/10; B32B 5/266; B32B 7/022; B32B 7/09; B32B 7/12; B32B 15/02; B32B 15/14; B32B 15/18; B32B 2262/0253; B32B 2262/0276; B32B 2262/148; B32B 2307/536; B32B 2307/581; B32B 2307/54; B32B 2307/732; B32B 2439/46; E05B 73/0005

(57) ABSTRACT

An antitheft device includes, a lock bag with a bag portion made from a cut-resistant material and a cable guide; and a cable lock, including a lock body, a lock cable, and a key; such that the lock cable protrudes through the cable guide to attach the cable lock to the lock bag; such that the lock body is positionable over a side mirror of a vehicle, with the side mirror inside an interior of the bag portion, such that the side mirror antitheft device can be secured and locked in position on the side mirror, thereby preventing theft of a mirror portion of the side mirror. Additionally, the antitheft device can be secured in position with the lock cable attached to a mounting structure with the lock bag closed and a personal object locked in the interior of the lock bag, thereby preventing theft of the personal object.

### CROSS-REFERENCE TO RELATED APPLICATIONS

This application is a continuation-in-part of U.S. Non-Provisional application Ser. No. 16/695,039, filed Nov. 25, 2019, which is a continuation-in-part of U.S. Non-Provisional application Ser. No. 16/417,556, filed May 20, 2019; both of which are hereby incorporated herein by reference in their entirety.

### FIELD OF THE INVENTION

The present invention relates generally to the field of vehicle antitheft devices, and more particularly to methods and systems for securing a vehicle rear-view side mirror from theft.

### BACKGROUND OF THE INVENTION

Vehicle side mirrors have in recent years become increasingly complicated including new electronic features, such as auto-dimming and in-built heating. Consequently, replacement of vehicle side mirrors is becoming increasingly expensive.

Due to the emerging secondary market for replacement side mirrors, they have become a target for thieves, which are able to quickly remove the mirror mechanism. However, while this is becoming an increasing problem, vehicle owners have no effective options available in the market place for protecting their side mirrors against theft.

As such, considering the foregoing, it may be appreciated that there continues to be a need for novel and improved devices and methods for securing a vehicle rear-view side mirror from theft.

### SUMMARY OF THE INVENTION

The foregoing needs are met, to a great extent, by the present invention, wherein in aspects of this invention, enhancements are provided to the existing model of devices and methods for securing a vehicle rear-view side mirror from theft.

In an aspect, a side mirror antitheft device, can include:
a) a lock bag, which can be made from a cut-resistant material, wherein the lock bag can include:
   a bag portion, which can be put over a side mirror, of a vehicle; and
   a cable guide, which can be mounted to an outer periphery of the bag portion along an opening to the interior of the bag portion, such that the cable guide for example can be:
      a continuous tube; or
      a plurality of reinforced holes; and
b) a cable lock, which can include:
   a lock body;
   a lock cable, which can be releasably lockable onto the lock body, such that the lock cable forms a closed loop with a loop opening, when the cable lock is locked; and
   a key, which is configured to lock and unlock the lock body, to secure and release the lock cable;
wherein the lock cable protrudes through the cable guide, such that the cable lock is attached to the lock bag;
such that the lock body can be positioned over a side mirror of a vehicle, with the side mirror inside an interior of the bag portion, when the side mirror antitheft device is unlocked; and
such that the side mirror antitheft device is secured in position on the side mirror, thereby preventing theft of the mirror portion of the side mirror, when the side mirror antitheft device is locked onto the side mirror.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a side mirror antitheft device before installation on a side mirror of a vehicle, according to an embodiment of the invention.

FIG. 2 is a perspective view of a side mirror antitheft device, which is installed on a side mirror of a vehicle, according to an embodiment of the invention.

FIG. 3 is a perspective view of a side mirror antitheft device in a locked configuration, according to an embodiment of the invention.

FIG. 4A is a top view of parts of a lock bag of a side mirror antitheft device, prior to assembly, according to an embodiment of the invention.

FIG. 4B is a perspective view of a lock bag that is assembled from the parts shown in FIG. 4A, according to an embodiment of the invention.

FIG. 5A is a schematic view of a cut-resistant material, according to an embodiment of the invention.

FIG. 5B is a schematic view of a cut-resistant material, according to an embodiment of the invention.

FIG. 6A is a perspective view of an antitheft device in an open configuration, according to an embodiment of the invention.

FIG. 6B is a perspective view of an antitheft device in an open configuration with an object partially inserted, according to an embodiment of the invention.

FIG. 6B is a perspective view of an antitheft device in an open configuration with an object partially inserted, according to an embodiment of the invention.

FIG. 6C is a perspective view of an antitheft device in a locked configuration with an object in an interior of the antitheft device, according to an embodiment of the invention.

FIG. 6D is a perspective view of an antitheft device in a locked configuration and attached to a mounting structure, with an object in an interior of the antitheft device, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

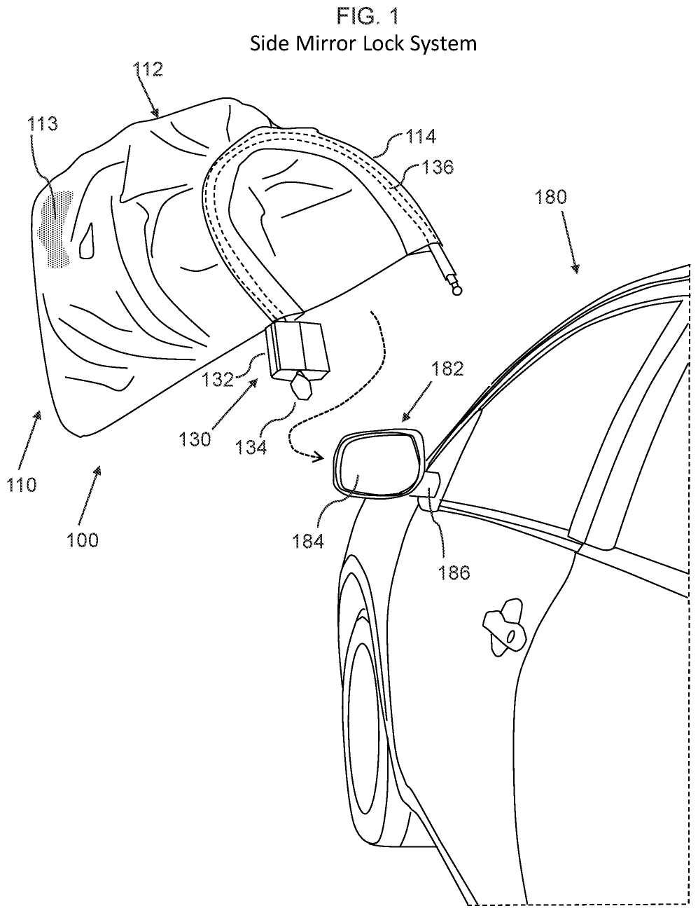

In the following, we describe the structure of an embodiment of a side mirror antitheft device 100 with reference to FIG. 1, in such manner that like reference numerals refer to like components throughout; a convention that we shall employ for the remainder of this specification.

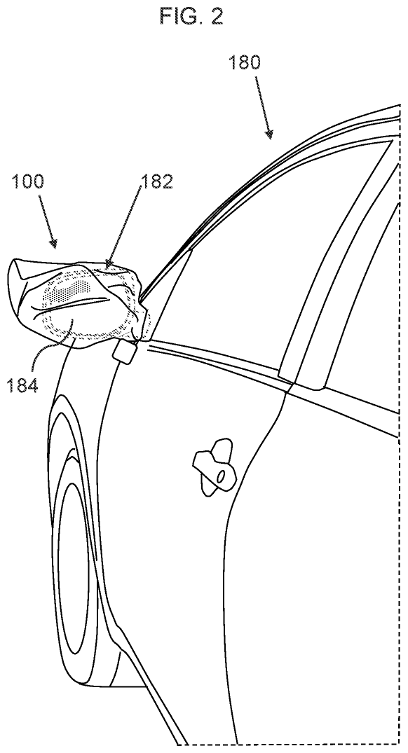

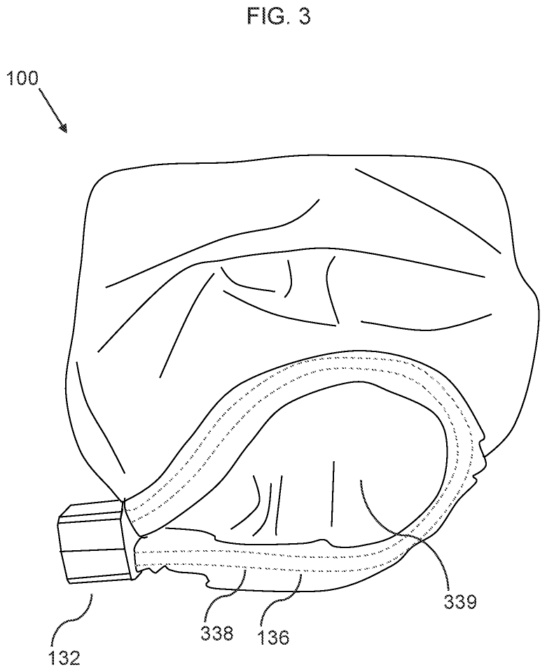

In an embodiment, as shown in FIG. 1, a side mirror antitheft device 100, can include:
a) a lock bag 110, which can include:
   i. a bag portion 112, which can be made from a cut-resistant material 113, wherein the bag portion 112 can be configured such that it can be put over a side mirror 182 of a vehicle 180; and
   ii. a cable guide 114, which can be mounted to an outer periphery of the bag portion along an opening to the interior of the bag portion, such that the cable guide can be:
      1. a continuous tube 114 (also called a hem 114 or casing 114; for example, formed by folding and sewing the outer ends of the material used for the bag portion); or
      2. a plurality of reinforced holes in the cut-resistant material 113 or guide segments, which allows a lock cable 136 of a cable lock 130 to be laced through the plurality of holes or guide segments; and
b) a cable lock 130, which can include:
   i. a lock body 132, which for example can be locked and unlocked with a key 134 or other locking mechanism;
   ii. a lock cable 136, which can be releasably lockable onto the lock body 132, such that the cable lock 130 and lock cable 136 forms a closed loop 338 with a loop opening 339, when the cable lock 130 is locked, as shown in FIG. 3; and
   iii. a key 134, which is configured to lock and unlock the lock body 132, to secure and release the lock cable 136;
wherein the lock cable 136 protrudes through the cable guide, such that the cable lock 130 is attached to the lock bag 110;
such that the lock body 132 can be positioned (i.e. is positionable) over a side mirror 182 of a vehicle 180, with the side mirror inside an interior of the bag portion, when the side mirror antitheft device 100 is unlocked, such that a bag opening to an interior of the bag portion 112 is maximized, as shown in FIG. 1; and
such that the side mirror antitheft device 100 is secured in position on the side mirror 182, such that the lock cable 636 is locked around a stem 186 of the side mirror 182 with the stem 186 protruding through the loop opening 339, such that the loop opening 339 is too small to allow removal of the antitheft device 100, thereby preventing theft of the mirror portion 184 of the side mirror 182, when the side mirror antitheft device 100 is locked onto the side mirror 182, as shown in FIG. 2. FIG. 3 shows the side mirror antitheft device 100 in a locked configuration.

In related embodiments, the cut-resistant material 113, can be a metal mesh or chainmail material, a kevlar composite, a high performance poly ethylene material, a weave of steelfibre or fiberglass, and can for example include:
a) KEVLAR™ fabric, i.e. a fabric made from Poly-paraphenylene terephthalamide, including KEVLAR™ fabrics reinforced with carbon fiber;
b) CTU-TEX PRO™;
c) CUTLON 3130™;
d) HEXARMOR SUPERFABRIC™;
e) Ultra-high-molecular-weight polyethylene (UHMWPE);
f) A combination of UHMWPE, polyester and fiberglass;
g) A combination of these; and/or
h) Other anti-cut or cut-resistant fabric materials.

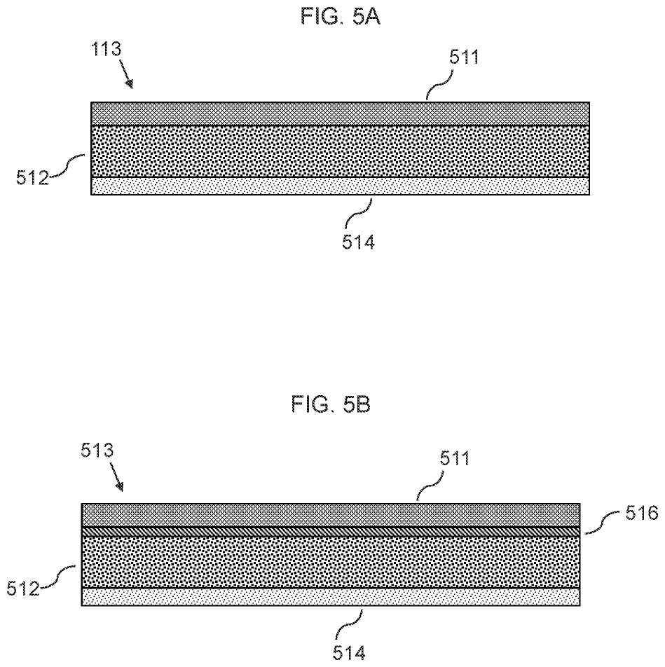

In a related embodiment, as shown in FIG. 5A, the cut-resistant material 113, can be configured as a composite multi-layer material, wherein the cut-resistant material 113 can include:
a) an outer cut-resistant layer 511, which can be made from a relatively hard material, which is both relatively strong and relatively hard, such as for example: a woven fabric made from UHMWPE (Ultra-High Molecular Weight Polyethylene), which can be configured with a 0.025 inch thickness, or 0.7 mm, or with a thickness in a range of 0.010-0.075 inches, and a weight of 320 gsm; or in a range of 270-370 gsm, wherein the extremely high molecular weight yields several unique properties including chemical inertness, lubricity, high abrasion resistance and impact strength;
b) a central penetration-resistant layer 512, which can be made from a relatively tough material, which is both relatively strong and relatively ductile, such as for example a nonwoven fabric made from 100% HPPE (High Performance Polyethylene), which can be configured with a 0.100″ thickness, or with a thickness in a range of 0.050-0.150 inches, and a weight of 220 gsm; or in a range of 170-270 gsm;
wherein the outer cut-resistant layer 511 is substantially harder than the central penetration-resistant layer 512, such as for example at least 50% harder than the central penetration-resistant layer 512 (as measured by an appropriate hardness unit of measure, such as Shore durometer type A, B, C, D, E, M, 0, 00, D0, 0000, or 000-S, etc.); and
wherein the central penetration-resistant layer 512 is substantially more ductile than the outer cut-resistant layer 511, such as for example at least 50% more ductile than the outer cut-resistant layer 511 (as measured by an appropriate ductility unit of measure, such as percent/relative elongation [engineering strain at fracture] or percent/relative reduction of area at fracture);
wherein the central penetration-resistant layer 512 is thicker than the outer cut-resistant layer 511, such as for example at least 50% thicker than the outer cut-resistant layer 511; and
c) an inner soft layer 514, which can be made of a relatively soft material, which is softer than the cut-resistant material 113, such as for example a 100% Polyester fabric, which can be configured with a 0.020 inch thickness, or with a thickness in a range of 0.010-0.050 inches;
wherein the inner soft layer 514 can protect the side mirror 182 from being scratched by the bag portion 112, particularly if the cut-resistant material 113 comprises a hard material such as a stainless steel fabric or chainmail. The inner soft layer 514 can for example be a soft fabric that is glued or sewed onto the inner side, or can be made from a rubber material, for example in the form of a rubber layer 514 or rubber coating 514 that is applied to, such as glued or fused onto, the inner side.

In a further related embodiment, the outer cut-resistant layer 511, can be a composite material, which can include:
a) Ultra-High Molecular Weight Polyethylene, in a proportion of 66% or 60-70% by weight;
b) Fiberglass, in a proportion of 21% or 15-25% by weight; and
c) Polyester, in a proportion of 21% or 15-25% by weight.

In further related embodiments, the outer cut-resistant layer 511, the central penetration-resistant layer 512, and the inner soft layer 514, can be permanently connected using well-known methods for connecting fabric or material sheet layers, such that the layers for example can be sewn, glued, and/or fused (i.e., by at least one or a combination of these methods).

In another further related embodiment, the outer cut-resistant layer 511 can be reinforced with poly-paraphenylene terephthalamide.

In yet a further related embodiment, as shown in FIG. 513, the cut-resistant material 513, 113, can further include:
a) an intermediate layer 516, which is positioned between the outer cut- resistant layer 511 and the central penetration-resistant layer 512, wherein the intermediate layer 516 can be made from a hard strong material, such as perforated stainless steel, such as a stainless steel mesh or weave, or KEVLAR™ reinforced composite weave or mesh, which can be configured with a 0.025 inch thickness, or with a thickness in a range of 0.010-0.1 inches.

In various further related embodiment, the cut-resistant material 513, 113, can further include additional layers and combinations of materials.

In other related embodiments, the cable lock 130 can be any high strength cable lock, for example made of high-strength steel, such as PYTHON™, keyed, or combination cable locks from MASTER LOCK™, or any other cable lock from other manufacturers. The lock cable 136 can be permanently secured to the lock body 132 in a first end of the lock cable 136, such that a second end of the lock cable 136 is releasably lockable to the lock body 132. Alternatively, first and second ends of the lock cable 136 can include respectively first and second loops, such that the lock body 132 is a pad lock 132, such that the lock cable 136 is locked closed with the pad lock 132.

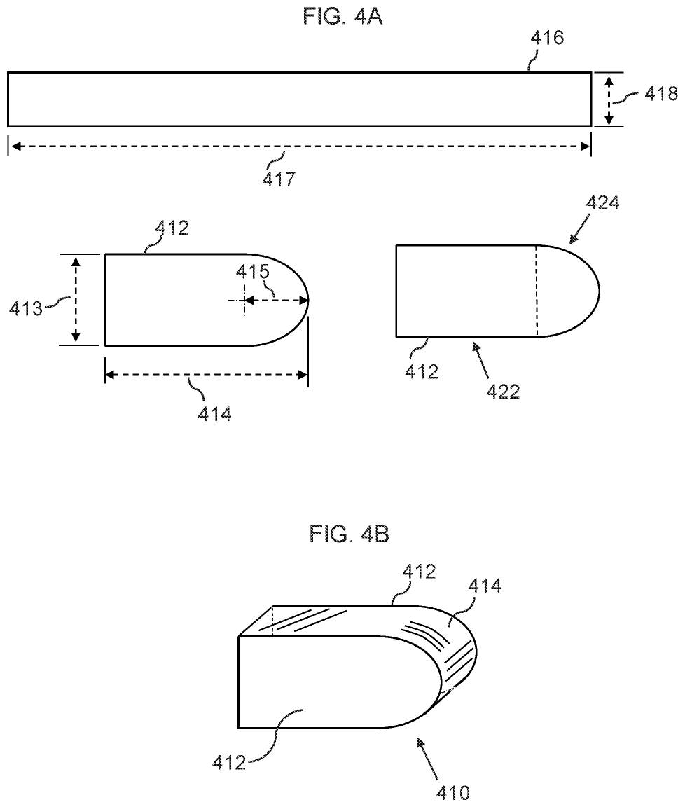

In a related embodiment, as shown in FIGS. 4A and 4B, a lock bag 410 can be manufactured from center portion 416, which is connected (such as sewn, glued, or fused) between two side portions 412. As shown, the center portion 416 can be an elongated rectangular piece, for example with a center length 417 of 38 inches and a width 418 of 5 inches. The first and second side portions 412 can each include a front rectangular piece 422 connected with a rear curved section 424, which can be half circle, half ellipsoid, or half parabolic curve; for example with a front length 414 of 18 inches and a height 413 of 9 inches of the front rectangular piece 422, and a center radius 415 of the rear curved section of 6 inches. Alternatively, the center portion 416 can have a center length 417 of 30-46 inches and a width 418 of 2-8 inches, and the first and second side portions 412 each can have a front rectangular piece with a front length 414 of 12-24 inches and a height 413 of 6-12 inches, and a center radius 415 of the rear curved section of 3-9 inches.

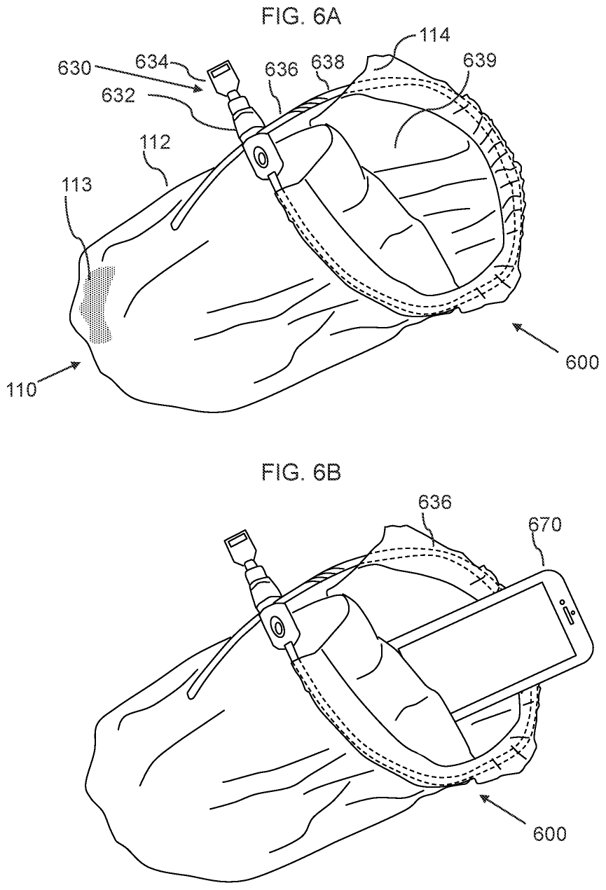

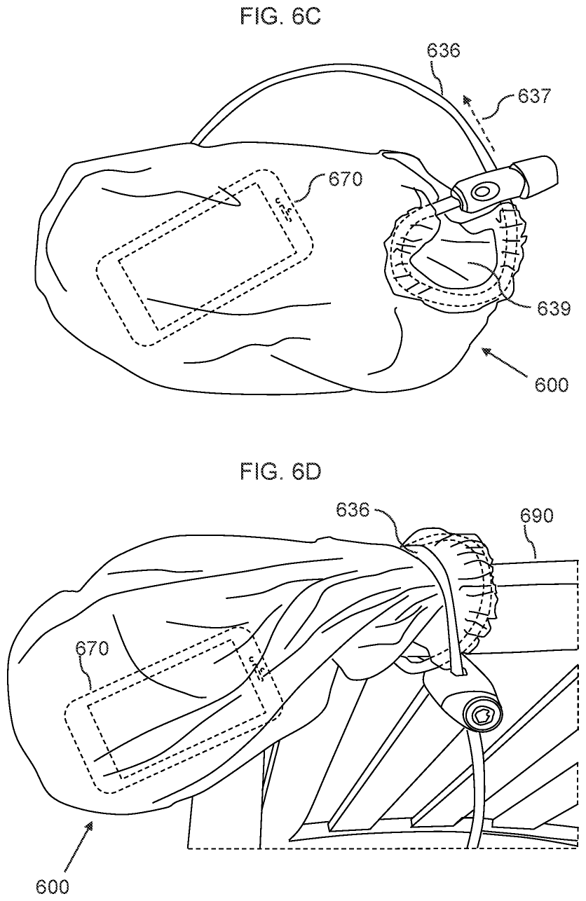

In another embodiment, as shown in FIGS. 6A, 6B, 6C, and 6D, an antitheft device 600, can include:
a) a lock bag 110, which can include:
   i. a bag portion 112, which can be made from a cut-resistant material 113, wherein the bag portion 112 can be configured to contain an object 670; and
   ii. a cable guide 114, which can be mounted to an outer periphery of the bag portion along an opening to the interior of the bag portion, such that the cable guide can be:
      1. a continuous tube 114 (also called a hem 114 or casing 114; for example, formed by folding and sewing the outer ends of the material used for the bag portion); or
      2. a plurality of reinforced holes in the cut-resistant material 113 or guide segments, which allows a lock cable 136 of a cable lock 130 to be laced through the plurality of holes or guide segments; and
b) a cable lock 630, which can include:
   i. a lock body 632, which for example can be locked and unlocked with a key 634 or other locking mechanism;
   ii. a lock cable 636, which can be releasably lockable onto the lock body 632, such that the lock body 632 and lock cable 636 form a closed loop 638 with a loop opening 639, when the cable lock 630 is locked; and
   iii. a key 634, which is configured to lock and unlock the lock body 632, to secure and release the lock cable 636;
wherein the lock cable 636 protrudes through the cable guide, such that the cable lock 630 is attached to the lock bag 110;
whereby an object 670, such as a mobile device 670 or key, etc., can be positioned in an interior of the lock bag 110, when the side mirror antitheft device 100 is unlocked, as shown in FIGS. 6A and 6B; and
whereby the antitheft device 600 can be secured in position (i.e. is securable in position) with the lock cable 636 securely attached to a mounting structure 690, such as a pool chair 690, rail, or other structure, for example such that the lock cable 636 is wrapped around the mounting structure 690 or penetrates through the mounting structure 690, and with the lock bag 110 closed with the object 670 locked in the interior of the lock bag 110, thereby preventing theft of the object 670, when the antitheft device 600 is closed tight and locked onto the mounting structure 690, as shown in FIGS. 6C and 6D. FIG. 6D shows that the lock cable 636 can be wrapped an extra turn around the mounting structure 690.

In a related embodiment, as shown in FIG. 6A, 6B, 6C, and 6D, the cable lock 630 can be configured such that the lock cable 636 protrudes through the lock body 632, such that the lock cable 636 can be tightened 637 and locked with a minimal loop opening 639, by pulling on an outer end of the lock cable 636, such that the object is locked inside the bag portion 112 and cannot be removed via the minimal loop opening 639.

Thus, in related embodiments, the antitheft device 100, 600 can be used to secure personal objects 670 at public places, such as at a public pool or at the beach, and the antitheft device 100, 600 can be used to prevent theft of a mirror portion 184 of a side mirror 182 of a vehicle 180.

Here has thus been described a multitude of embodiments of the antitheft device 100, 600, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. An antitheft device, comprising:
a) a lock bag, which is made from a cut-resistant material, wherein the lock bag comprises:
a bag portion, which is configured to be put over a side mirror of a vehicle; and
a cable guide, which is mounted to an outer periphery of the bag portion, along a bag opening to an interior of the bag portion; and
b) a cable lock, which comprises:
a lock body; and
a lock cable, which is releasably lockable to the lock body, such that the lock cable forms a closed loop with a loop opening, when the cable lock is locked;
wherein the lock cable protrudes through the cable guide, such that the cable lock is attached to the lock bag;
whereby the lock bag is positionable over the side mirror with the side mirror inside the interior of the bag portion, when the antitheft device is unlocked; and
whereby the antitheft device is secured in position on the side mirror, thereby preventing theft of a mirror portion of the side mirror, when the antitheft device is locked onto the side mirror.

2. The antitheft device of claim 1, wherein the cable guide is a continuous tube.

3. The antitheft device of claim 1, further comprising a key, wherein the key is configured to lock and unlock the lock body.

4. The antitheft device of claim 1, wherein the cut-resistant material comprises:
a) an outer cut-resistant layer; and
b) a central penetration-resistant layer, which is positioned on an inner side of the outer cut-resistant layer;
wherein the outer cut-resistant layer is harder than the central penetration-resistant layer; and
wherein the central penetration-resistant layer is more ductile than the outer cut-resistant layer; and
wherein the central penetration-resistant layer is thicker than the outer cut-resistant layer.

5. The antitheft device of claim 4, wherein:
a) the outer cut-resistant layer is at least 50% harder than the central penetration-resistant layer;
b) the central penetration-resistant layer is at least 50% more ductile than the outer cut-resistant layer; and
c) wherein the central penetration-resistant layer is at least 50% thicker than the outer cut-resistant layer.

6. The antitheft device of claim 5, wherein the outer cut-resistant layer is a woven fabric made from ultra-high molecular weight polyethylene, which is configured with a first thickness in a range of 0.010-0.075 inches; wherein the central penetration-resistant layer is a nonwoven fabric made from high performance polyethylene, which is configured with a second thickness in a range of 0.050-0.150 inches.

7. The antitheft device of claim 6, wherein the outer cut-resistant layer is reinforced with poly-paraphenylene terephthalamide.

8. The antitheft device of claim 5, wherein the cut-resistant material further comprises:
an intermediate layer, which is positioned between the outer cut-resistant layer and the central penetration-resistant layer, wherein the intermediate layer is configured as a stainless steel mesh with a thickness in a range of 0.010-0.1 inches.

9. The antitheft device of claim 5, wherein the cut-resistant material further comprises:
an inner soft layer, which is positioned on an inner side of the central penetration-resistant layer, wherein the inner soft layer is softer than the central penetration-resistant layer.

10. The antitheft device of claim 9, wherein the inner soft layer is made from polyester, with a thickness in a range of 0.010-0.050 inches.

11. The antitheft device of claim 1, wherein the bag portion comprises:
a) a center portion;
b) a first side portion; and
c) a second side portion;
wherein the center portion is connected between the first and second side portions.

12. The antitheft device of claim 11, wherein the center portion is an elongated rectangular piece and the first and second side portions each include a front rectangular piece and a rear curved section, such that the rear curved section is connected to a rear of the front rectangular piece.

13. The antitheft device of claim 12, wherein the center portion has a center length in a range of 30-46 inches and a width in a range of 2-8 inches, and the front rectangular piece has a front length in a range of 12-24 inches and a height in a range of 6-12 inches, and the rear curved section has a center radius in a range of 3-9 inches.

14. An antitheft device, comprising:
a) a lock bag, which is made from a cut-resistant material, wherein the lock bag comprises:
a bag portion, which is configured to contain an object; and
b) a cable lock, which comprises:
a lock body; and
a lock cable, which is releasably lockable to the lock body, such that the lock cable forms a closed loop with a loop opening, when the cable lock is locked;
wherein the lock cable is attached to an outer periphery of the bag portion, along a bag opening to an interior of the bag portion;
such that the object is positionable in the interior of the bag portion, when the antitheft device is unlocked; and
such that the antitheft device is securable in position with the lock cable securely attached to a mounting structure and the lock bag closed with the object locked in the interior of the bag portion, when the antitheft device is locked, thereby preventing theft of the object.

15. The antitheft device of claim 14, wherein the cut-resistant material comprises:
a) an outer cut-resistant layer; and
b) a central penetration-resistant layer, which is positioned on an inner side of the outer cut-resistant layer;
wherein the outer cut-resistant layer is harder than the central penetration-resistant layer; and
wherein the central penetration-resistant layer is more ductile than the outer cut-resistant layer; and
wherein the central penetration-resistant layer is thicker than the outer cut-resistant layer.

16. The antitheft device of claim 15, wherein:
a) the outer cut-resistant layer is at least 50% harder than the central penetration-resistant layer;
b) the central penetration-resistant layer is at least 50% more ductile than the outer cut-resistant layer; and
c) wherein the central penetration-resistant layer is at least 50% thicker than the outer cut-resistant layer.

17. The antitheft device of claim 16, wherein the outer cut-resistant layer is a woven fabric made from ultra-high molecular weight polyethylene, which is configured with a first thickness in a range of 0.025-0.075 inches; wherein the central penetration-resistant layer is a nonwoven fabric made from high performance polyethylene, which is configured with a second thickness in a range of 0.050-0.150 inches.

18. The antitheft device of claim 16, wherein the cut-resistant material further comprises:
an inner soft layer, which is positioned on an inner side of the central penetration-resistant layer, wherein the inner soft layer is softer than the central penetration-resistant layer.

19. The antitheft device of claim 18, wherein the inner soft layer is made from polyester, with a thickness in a range of 0.010-0.050 inches.

20. The antitheft device of claim 14, wherein the bag portion comprises:
a) a center portion;
b) a first side portion; and
c) a second side portion;
wherein the center portion is connected between the first and second side portions.

21. The antitheft device of claim 20, wherein the center portion is an elongated rectangular piece and the first and second side portions each include a front rectangular piece and a rear curved section, such that the rear curved section is connected to a rear of the front rectangular piece.

22. The antitheft device of claim 21, wherein the center portion has a center length in a range of 30-46 inches and a width in a range of 2-8 inches, and the front rectangular piece has a front length in a range of 12-24 inches and a height in a range of 6-12 inches, and the rear curved section has a center radius in a range of 3-9 inches.
